(19) United States
(12) Patent Application Publication
(10) Pub. No.: US 2016/0182576 A1
(43) Pub. Date: Jun. 23, 2016

(54) Electronic Meetings with Known Participants but Anonymous Comments

(71) Applicant: Plantronics, Inc., Santa Cruz, CA (US)

(72) Inventors: Benjamin Kromnick, Santa Cruz, CA (US); Timothy P. Johnston, Los Gatos, CA (US); Richard A. Dunning, JR., Los Gatos, CA (US)

(73) Assignee: Plantronics, Inc., Santa Cruz, CA (US)

(21) Appl. No.: 14/575,684

(22) Filed: Dec. 18, 2014

(51) Int. Cl. H04L 29/06; H04L 29/08; G06N 3/00; H04L 12/58

(52) U.S. Cl. CPC H04L 65/403; H04L 51/046; H04L 67/10; G06N 3/006

(57) ABSTRACT

Computer-readable media embodying instructions executable by a computer to perform functions having corresponding methods comprise: joining a user of the computer to an electronic meeting; causing a display device to display a list of participants in the electronic meeting; receiving electronic messages, wherein each electronic message comprises a comment contributed by one of the participants; and causing the display device to display each comment without displaying an identity of the participant who contributed the comment.

### FIELD

The present disclosure relates generally to the field of electronic collaboration and messaging. More particularly, the present disclosure relates to communication by text or voice for groups.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

An important goal in the modern enterprise is the facilitation of communication and collaboration among employees. Applications such as email and instant messaging forward this goal. Some instant messaging applications enable electronic meetings among multiple participants who may be dispersed throughout the enterprise or even the world. These applications allow participants to submit comments that are reproduced for the other participants, for example as text displayed on a computer screen or audio played over computer speakers or headsets. For text meetings, each comment is attributed to its author, for example by displaying a photo of the author next to the comment.

In some cases it is desirable to discuss topics that are controversial, to have a free exchange of ideas that may not be fully developed, or the like. In such cases, participants may limit their participation or censor their comments for fear of ridicule, retribution or other adverse consequences that may be personal, social, political, or professional in nature.

### SUMMARY

In general, in one aspect, an embodiment features computer-readable media embodying instructions executable by a computer to perform functions comprising: joining a user of the computer to an electronic meeting; causing a display device to display a list of participants in the electronic meeting; receiving electronic messages, wherein each electronic message comprises a comment contributed by one of the participants; and causing the display device to display each comment without displaying an identity of the participant who contributed the comment.

Embodiments of the computer-readable media may include one or more of the following features. In some embodiments, the electronic messages are first electronic messages, and the functions further comprise: responsive to input from the user of the computer, sending a second electronic message to a participant who contributed a comment, the second electronic message comprising a request for an identity of the participant who contributed the comment; receiving a third electronic message, the third electronic message comprising the identity of the participant who contributed the comment; and responsive to receiving the third electronic message, causing the display device to display the identity of the participant who contributed the comment. In some embodiments, the electronic messages are first electronic messages, and the functions further comprise: responsive to input from the user of the computer, sending a second electronic message to a participant who contributed a comment, the second electronic message comprising a request to capture the comment; receiving a third electronic message, the third electronic message granting the request; and responsive to the third electronic message, allowing the user of the computer to capture the comment within the electronic meeting. In some embodiments, the electronic messages are first electronic messages, the electronic meeting is a first electronic meeting, and the functions further comprise: responsive to input from the user of the computer, sending a second electronic message to a participant who contributed a comment, the second electronic message comprising a request to provide the comment to a second electronic meeting; receiving a third electronic message, the third electronic message granting the request; and responsive to the third electronic message, allowing the user of the computer to provide the comment to the second electronic meeting. In some embodiments, the second electronic message further comprises a request for an identity of the participant who contributed the comment; the third electronic message comprises the identity of the participant who contributed the comment; and the functions further comprise causing the display device to display the identity of the participant who contributed the comment responsive to the third electronic message. In some embodiments, one of the electronic messages includes an indication of one of a plurality of conviction levels for the respective comment; and the functions further comprise causing the display device to indicate the one of the plurality of conviction levels for the respective comment responsive to receiving the one of the electronic messages. In some embodiments, one of the participants is associated with an avatar that does not indicate an identity of the participant; and the functions further comprise causing the display device to display the avatar with comments contributed by the one of the participants. In some embodiments, the functions further comprise: causing the display device to display each electronic message only for a predetermined interval. In some embodiments, the functions further comprise: preventing the user of the computer from contributing a comment to the electronic meeting while another participant is contributing a comment to the electronic meeting. In some embodiments, the functions further comprise: preventing the user of the computer from capturing a display of the computer during the electronic meeting.

In general, in one aspect, an embodiment features a method comprising: joining a user to an electronic meeting; displaying a list of participants in the electronic meeting; receiving electronic messages, wherein each electronic message comprises a comment contributed by one of the participants; and displaying each comment without displaying an identity of the participant who contributed the comment.

Embodiments of the method may include one or more of the following features. In some embodiments, the electronic messages are first electronic messages, and the method further comprises: responsive to input from the user, sending a second electronic message to a participant who contributed a comment, the second electronic message comprising a request for an identity of the participant who contributed the comment; receiving a third electronic message, the third electronic message comprising the identity of the participant who contributed the comment; and responsive to receiving the third electronic message, displaying the identity of the participant who contributed the comment. In some embodiments, the electronic messages are first electronic messages, and the method further comprises: responsive to input from the user, sending a second electronic message to a participant who contributed a comment, the second electronic message comprising a request to capture the comment; receiving a third electronic message, the third electronic message granting the request; and responsive to the third electronic message, allowing the user to capture the comment within the electronic meeting. In some embodiments, the electronic messages are first electronic messages, the electronic meeting is a first electronic meeting, and the method further comprises: responsive to input from the user, sending a second electronic message to a participant who contributed a comment, the second electronic message comprising a request to provide the comment to a second electronic meeting; receiving a third electronic message, the third electronic message granting the request; and responsive to the third electronic message, allowing the user to provide the comment to the second electronic meeting. In some embodiments, the second electronic message further comprises a request for an identity of the participant who contributed the comment; the third electronic message comprises the identity of the participant who contributed the comment; and the method further comprises displaying the identity of the participant who contributed the comment responsive to the third electronic message. In some embodiments, one of the electronic messages includes an indication of one of a plurality of conviction levels for the respective comment; and the method further comprises indicating the one of the plurality of conviction levels for the respective comment responsive to receiving the one of the electronic messages. In some embodiments, one of the participants is associated with an avatar that does not indicate an identity of the participant; and the method further comprises displaying the avatar with comments contributed by the one of the participants. Some embodiments comprise displaying each electronic message only for a predetermined interval. Some embodiments comprise preventing the user from contributing a comment to the electronic meeting while another participant is contributing a comment to the electronic meeting. Some embodiments comprise preventing the user of the computer from capturing a display of the computer during the electronic meeting.

The details of one or more implementations are set forth in the accompanying drawings and the description below. Other features will be apparent from the description and drawings, and from the claims.

### DESCRIPTION OF DRAWINGS

FIG. 1 shows elements of electronic meeting system according to one embodiment.

FIG. 2 shows a process for the electronic meeting system of FIG. 1 according to one embodiment.

FIG. 3 shows a display of a list of participants in an electronic meeting according to one embodiment.

FIG. 4 shows the display of FIG. 3 updated to show a new comment submitted anonymously by a participant in the meeting.

FIG. 5 shows the display of FIG. 3 updated to show the identity of the participant who contributed a comment.

FIG. 6 shows the display of FIG. 3 updated to show a new comment submitted anonymously by a participant in the meeting, with the conviction level indicated by bold font.

FIG. 7 shows the display of FIG. 3 updated to show two anonymous comments attributed to one anonymous participant by an anonymous avatar.

The leading digit(s) of each reference numeral used in this specification indicates the number of the drawing in which the reference numeral first appears.

### DETAILED DESCRIPTION

Embodiments of the present disclosure provide electronic meetings with known participants but anonymous comments. That is, the identities of the meeting participants are revealed to all participants, but the comments contributed by the participants are not attributed to any participant. But in some embodiments, the identities of the meeting participants may not be revealed to the participants. Various embodiments include other features as well. One of the participants may identify himself as the contributor of one or more comments, of his own accord or responsive to a request from another participant. A comment may not leave the meeting without the permission of the contributor. The permission may include a release of the contributor's anonymity. For example, one of the participants may ask to extend a comment from the current meeting to another meeting, with or without identifying the contributor. As another example, a contributor may ask to capture a comment for later reference, again with or without identifying the contributor. One of the participants may add a conviction indicator to his comment to indicate his level of conviction for that comment. One of the participants may employ an anonymous avatar so that his comments may be considered together while he remains anonymous. The comments may be ephemeral, being deleted after a brief interval. This interval may be controlled by a meeting administrator. A lockout mechanism may be employed to prevent forks in the discussion, such that no participant may contribute a comment while another participant is contributing. The meeting may be structured such that comments are contributed and rendered in text or audio. In some embodiments, voice-to-text or text-to-voice applications may be employed to contribute and render comments. In audio meetings, anonymity may be implemented by voice anonymization. Other features are contemplated as well.

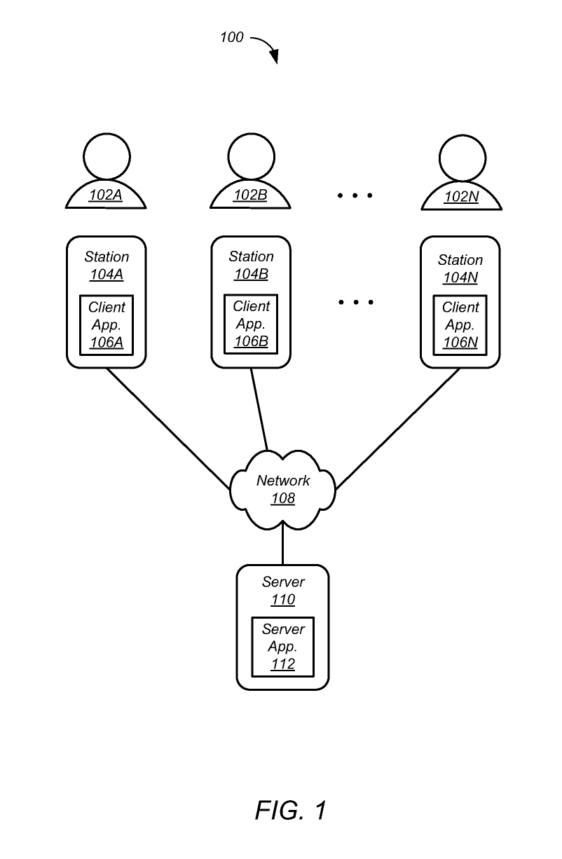

FIG. 1 shows elements of electronic meeting system 100 according to one embodiment. Although in the described embodiment elements of the electronic meeting system 100 are presented in one arrangement, other embodiments may feature other arrangements. For example, elements of the electronic meeting system 100 may be implemented in hardware, software, or combinations thereof. As another example, various elements of the electronic meeting system 100 may be implemented as one or more digital signal processors.

Referring to FIG. 1, the electronic meeting system 100 may include N stations 104A and 104B through 104N operated by respective users (also referred to herein as “participants”) 102A and 102B through 102N. Each station 104 may be implemented as a computer together with various input/output devices such as a keyboard, a mouse, a display, a microphone, a speaker, an audio headset, a network interface, and the like. Client applications 106A and 106B through 106N may execute on respective stations 104A and 104B through 104N. The stations 104 may communicate electronically over a communications network 108. The stations 104 may communicate directly with one another, using a server application 112 executing on a server 110, or both.

The client applications 106 may be implemented as stand-alone applications or as plug-ins, extensions, or the like for other applications. For example, each client application 106 may be implemented as a communications application such as an instant messaging application or the like or the like. As an alternative example, each client application 106 may be implemented as an HTML5 application executing within a window of a communications application such as an instant messaging application or the like. In any case, the client applications 106 may conduct the electronic meeting in a peer-to-peer manner, as clients to the server application 112, or both. The client applications 106 and server application 112 may connect to other servers to collect user information and the like.

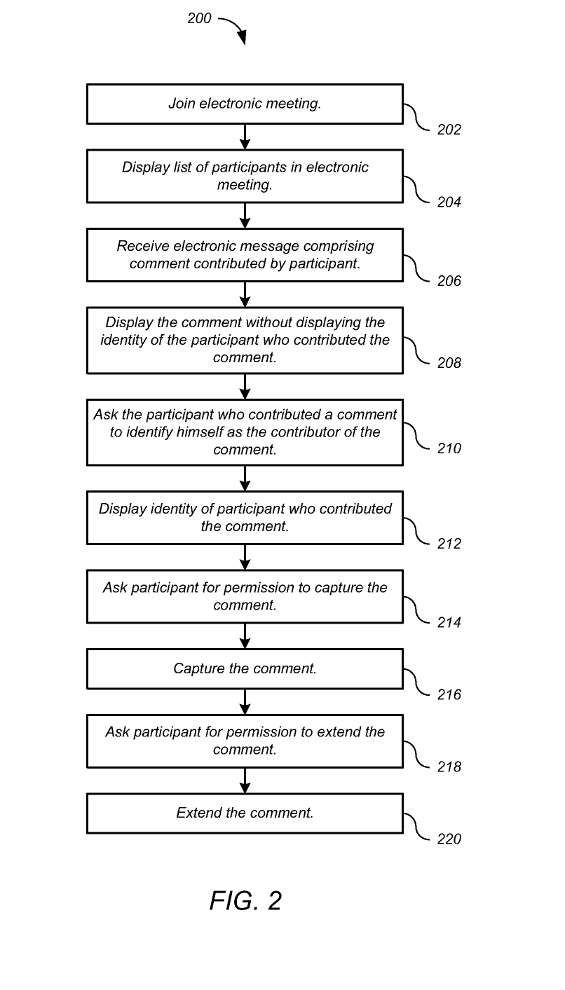

FIG. 2 shows a process 200 for the electronic meeting system 100 of FIG. 1 according to one embodiment. Although in the described embodiments the elements of process 200 are presented in one arrangement, other embodiments may feature other arrangements. For example, in various embodiments, some or all of the elements of process 200 can be executed in a different order, concurrently, and the like. Also some elements of process 200 may not be performed, and may not be executed immediately after each other. In addition, some or all of the elements of process 200 can be performed automatically, that is, without human intervention.

Referring to FIG. 2, at 202, a user 102A may employ his client application 106A to join an electronic meeting. Other participants 102 may join the electronic meeting before or after participant 102A. The client application 106A may join the electronic meeting as a standalone application, or may cause another application to join the electronic meeting. For example, the client application 106A may cause an instant messaging application to join the meeting.

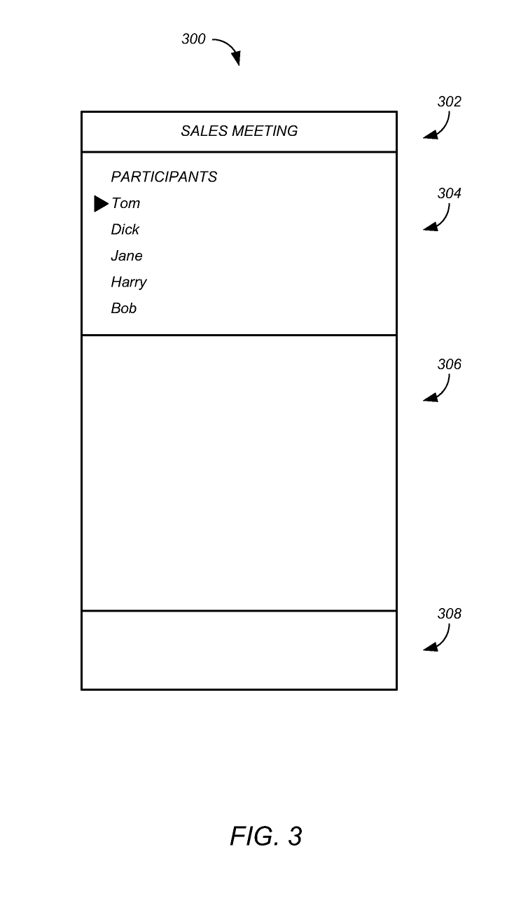

At 204, after joining the user to the electronic meeting, the client application 106A may cause a display device to display a list of participants 102 in the electronic meeting. FIG. 3 shows such a display 300 according to one embodiment. Referring to FIG. 3, display 300 includes a subject bar 302 showing the subject of the meeting, a participant list 304 listing participants 102 in the meeting, a comment area 306 showing comments contributed by the participants 102, and a contribution area 308 where the participant 102 using the client application 106A may contribute comments using an input device such as a keypad, a microphone and a voice interface application, or the like. The client application 106A indicates the identity of the participant 102 using the client application 106A, Tom, with a small triangle.

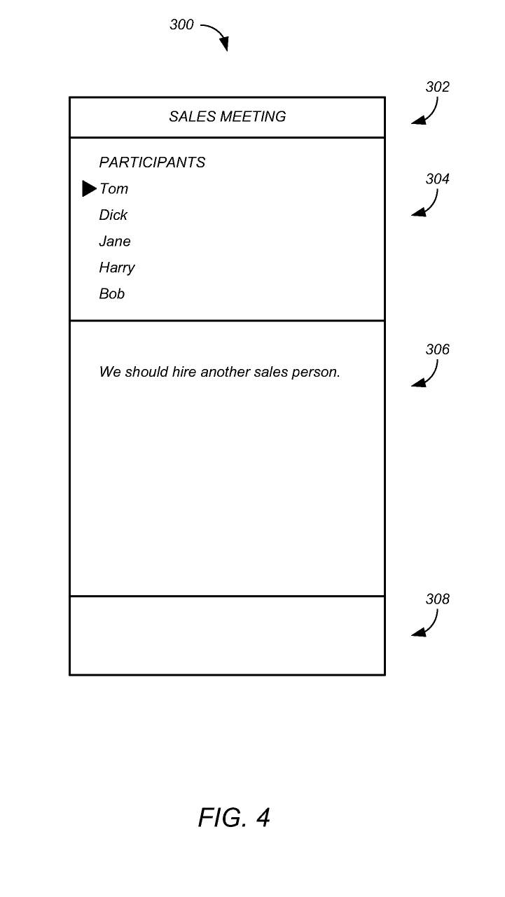

At 206, the client application 106A receives an electronic message comprising a comment contributed by a participant 102. At 208, the client application 106A causes the display device to display the comment without displaying the identity of the participant 102 who contributed the comment. FIG. 4 shows the display 300 of FIG. 3 updated to show the new comment. Note that the identity of the participant 102 who contributed the comment is not displayed.

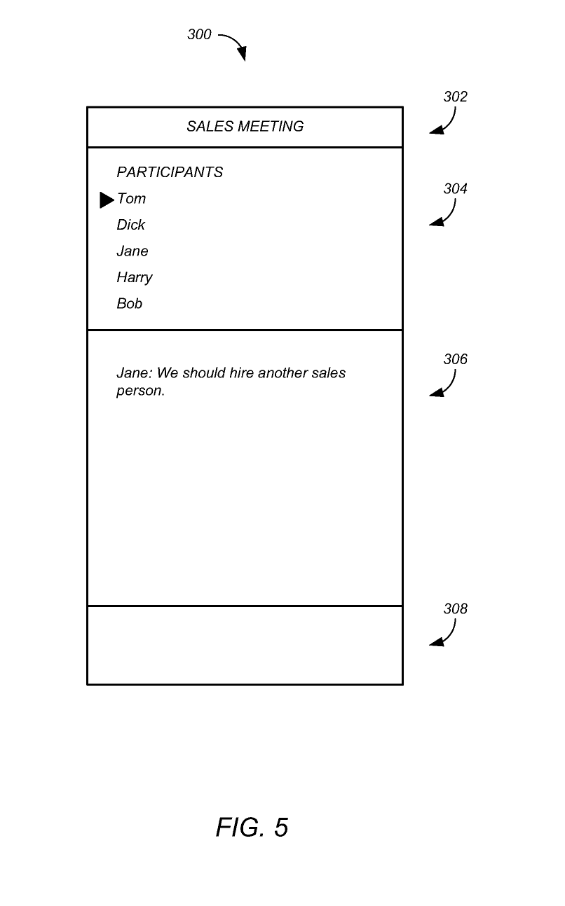

At 210, Tom may ask a participant 102 who has contributed a comment to identify himself as the contributor of the comment. For example, responsive to input from Tom using the client application 106A, the client application 106A may send an electronic message to the participant 102 who contributed the comment, where the second electronic message comprises a request for an identity of the participant 102 who contributed the comment. If the participant 102 who contributed the comment consents, the display device may display the identity of the participant 102 who contributed the comment next to the comment in the comment area 306 of the display 300, at 212. For example, the client application 106A may receive an electronic message that comprises the identity of the participant who contributed the comment, and responsive to that electronic message, may cause the display device to display the identity of the participant who contributed the comment. FIG. 5 shows the display 300 of FIG. 3 updated to show the identity of the participant 102 who contributed the comment. In the example of FIG. 5, the identity is shown by displaying the participant's name, Jane. However, other identification methods may be used instead or in addition, for example such as displaying a photo of the participant 102, an avatar, and the like.

In general, the comments contributed during an electronic meeting do not persist beyond that meeting. That is, the comments are deleted when the meeting ends or before then. However, some embodiments allow comments to be captured during the meeting or extended beyond the meeting.

Referring again to FIG. 2, at 214, Tom may ask Jane for permission to capture her comment. For example, responsive to input from Tom, the client application 106 may send an electronic message to Jane, wherein the electronic message comprises a request to capture the comment. In some embodiments, a participant 102 may request to capture a comment without knowing the identity of the participant 102 who contributed the comment. In response, the participant 102 who contributed the comment may grant the request and remain anonymous, or may grant the request only while revealing her identity. In some embodiments, the further capture or extension of a comment may be limited based on whether the comment was captured anonymously, based on whether the contributor allowed further capture or extension, and the like.

If the participant 102 who contributed the comment consents, the system 100 may capture the comment, at 216. That is, the system 100 may store the comment in a memory accessible to Tom. The memory may be located in Tom's station 104, in a remote server, or the like. For example, the client application 106A may receive an electronic message that grants the request to capture the comment, and responsive to that electronic message, may allow Tom to capture the comment within the electronic meeting.

In contrast to the capture of a comment, a participant 102 may ask to extend a comment, either after capturing the comment or without capturing the comment. Extending a comment comprises introducing that comment into a different electronic meeting. For example, a comment may inspire a participant 102 to create another meeting, possibly with a different set of participants, to discuss the comment. Referring again to FIG. 2, at 218, Tom may ask Jane for permission to extend her comment. For example, responsive to input from Tom, the client application 106 may send an electronic message to Jane, wherein the electronic message comprises a request to extend the comment. If the comment is anonymous, the electronic message may include a request for the identity of the participant who contributed the comment.

In some embodiments, a participant 102 may request to extend a comment without knowing the identity of the participant 102 who contributed the comment. In response, the participant 102 who contributed the comment may grant the request and remain anonymous, or may grant the request only while revealing her identity. In some embodiments, the further capture or extension of a comment may be limited based on whether the comment was captured anonymously, based on whether the contributor allowed further capture or extension, and the like.

If the participant 102 who contributed the comment consents, the system 100 may extend the comment, at 220. For example, the system 100 may store the comment in a memory accessible to Tom. For example, the client application 106A may receive an electronic message that grants the request to extend the comment, and responsive to that electronic message, may allow Tom to provide the comment to another electronic meeting.

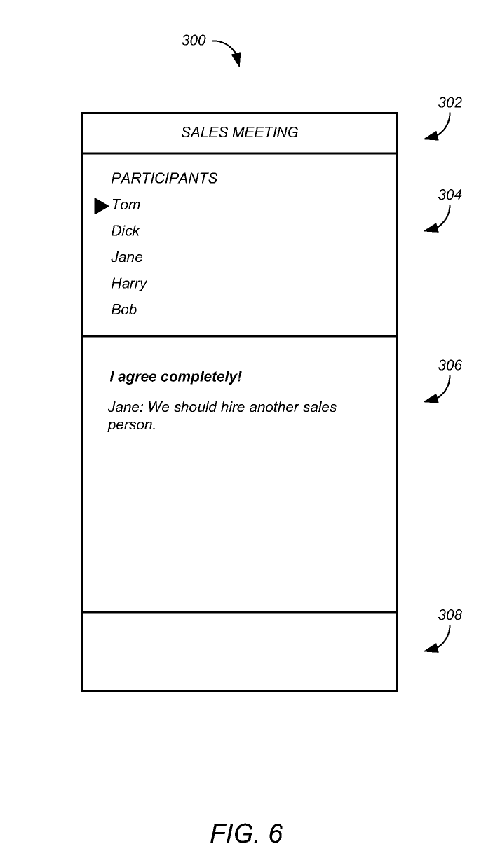

Some embodiments comprise a conviction meter by which a participant may indicate his degree of conviction for one of his comments. For example, the electronic message conveying a comment to the system 100 may include an indication of one of a plurality of conviction levels for that comment. Responsive to receiving the electronic message, the client application 106 may cause the display device to indicate the one of the plurality of conviction levels for the comment. The conviction level may be indicated in any manner, for example by font characteristics such as bold, italic, underline, size, color, capitalization, and the like, by characteristics of an icon displayed next to the comment, and the like. FIG. 6 shows the display 300 of FIG. 3 updated to show an anonymous comment, with the conviction level indicated by bold font. In embodiments where comments are rendered as voice, the conviction level may be indicated by loudness of the voice or the like.

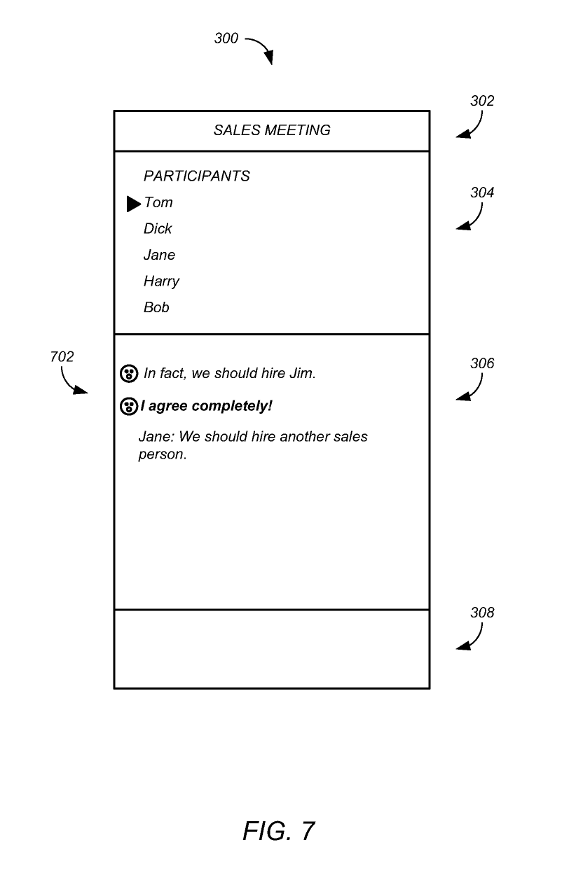

In some embodiments, a participant 102 may be associated with an avatar that does not indicate the identity of the participant. For example, the avatar may be a drawing of a cartoon character or the like. The system 100 may prevent two different participants from choosing the same avatar. Such use of an avatar allows the participant 102 to remain anonymous while attributing all of his comments to the same anonymous participant 102. For example, the client application 106 may cause the display device to display the avatar with comments contributed by the one of the participants. FIG. 7 shows the display 300 of FIG. 3 updated to show two anonymous comments attributed to one anonymous participant by an anonymous avatar, at 702.

In some embodiments, comments persist only for a predetermined interval before disappearing. For example, the client application 106 may cause the display device to display each electronic message only for that predetermined interval. Such embodiments may keep participants more engaged, for if they are not paying attention, they may miss an important comment, and may inspire more ephemeral and less formal responses because the response period is shortened.

In some embodiments, display capture may be disabled during the meeting. That is, a participant may not use his device to save the displayed content during the meeting, for example by taking a screenshot with the device. This feature helps to prevent participants from capturing comments submitted during the meeting.

In some embodiments, a lockout mechanism prevents any participant from contributing a comment while another participant 102 is contributing a comment. This policy may be enforced by the client applications 106, by the server application 112, or both. Priority may be allocated by first-come, by round-robin, or by any other technique. Such embodiments may keep discussions focused by preventing the discussion from “forking” into multiple threads.

In some embodiments, authentication of the participants is required. Any authentication technique may be used, including single sign-on, multi-factor authentication, the use of wearables, combinations thereof, and the like. Multiple levels of authentication may be implemented. The degree of authentication may be commensurate with the degree of confidentiality of the subject matter discussed. The degree of authentication required may be established and modified by an administrator.

In some embodiments, instead of, or in addition to, the use of text comments. the participants may submit voice comments. To preserve anonymity, the voices of the participants may be masked, replaced by voices such as those of celebrities, and the like. Anonymity may be released by removing the voice masking or replacement.

In some embodiments, participants may submit poll questions to the meeting. The poll questions may be answered anonymously or not, or a combination of the two based on the preferences of individual participants.

In some embodiments, participants may take notes within the meeting. The notes may be released to the meeting. The notes may be deleted at the end of the meeting, stored and associated with the meeting subject, or released to the meeting participants depending on the parameters set by an administrator.

Various embodiments of the present disclosure can be implemented in digital electronic circuitry, or in computer hardware, firmware, software, or in combinations thereof. Embodiments of the present disclosure can be implemented in a computer program product tangibly embodied in a computer-readable storage device for execution by a programmable processor. The described processes can be performed by a programmable processor executing a program of instructions to perform functions by operating on input data and generating output. Embodiments of the present disclosure can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, processors receive instructions and data from a read-only memory and/or a random access memory. Generally, a computer includes one or more mass storage devices for storing data files. Such devices include magnetic disks, such as internal hard disks and removable disks, magneto-optical disks; optical disks, and solid-state disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). As used herein, the term “module” may refer to any of the above implementations.

A number of implementations have been described. Nevertheless, various modifications may be made without departing from the scope of the disclosure. Accordingly, other implementations are within the scope of the following claims.

What is claimed is:

1. Computer-readable media embodying instructions executable by a computer to perform functions comprising:
joining a user of the computer to an electronic meeting;
causing a display device to display a list of participants in the electronic meeting;
receiving electronic messages, wherein each electronic message comprises a comment contributed by one of the participants; and
causing the display device to display each comment without displaying an identity of the participant who contributed the comment.

2. The computer-readable media of claim 1, wherein the electronic messages are first electronic messages, and wherein the functions further comprise:
responsive to input from the user of the computer, sending a second electronic message to a participant who contributed a comment, the second electronic message comprising a request for an identity of the participant who contributed the comment;
receiving a third electronic message, the third electronic message comprising the identity of the participant who contributed the comment; and
responsive to receiving the third electronic message, causing the display device to display the identity of the participant who contributed the comment.

3. The computer-readable media of claim 1, wherein the electronic messages are first electronic messages, and wherein the functions further comprise:
responsive to input from the user of the computer, sending a second electronic message to a participant who contributed a comment, the second electronic message comprising a request to capture the comment;
receiving a third electronic message, the third electronic message granting the request; and
responsive to the third electronic message, allowing the user of the computer to capture the comment within the electronic meeting.

4. The computer-readable media of claim 1, wherein the electronic messages are first electronic messages, wherein the electronic meeting is a first electronic meeting, and wherein the functions further comprise:
responsive to input from the user of the computer, sending a second electronic message to a participant who contributed a comment, the second electronic message comprising a request to provide the comment to a second electronic meeting;
receiving a third electronic message, the third electronic message granting the request; and
responsive to the third electronic message, allowing the user of the computer to provide the comment to the second electronic meeting.

5. The computer-readable media of claim 4, wherein:
the second electronic message further comprises a request for an identity of the participant who contributed the comment;
the third electronic message comprises the identity of the participant who contributed the comment; and
the functions further comprise causing the display device to display the identity of the participant who contributed the comment responsive to the third electronic message.

6. The computer-readable media of claim 1, wherein:
one of the electronic messages includes an indication of one of a plurality of conviction levels for the respective comment; and
the functions further comprise causing the display device to indicate the one of the plurality of conviction levels for the respective comment responsive to receiving the one of the electronic messages.

7. The computer-readable media of claim 1, wherein:
one of the participants is associated with an avatar that does not indicate an identity of the participant; and
the functions further comprise causing the display device to display the avatar with comments contributed by the one of the participants.

8. The computer-readable media of claim 1, wherein the functions further comprise:
causing the display device to display each electronic message only for a predetermined interval.

9. The computer-readable media of claim 1, wherein the functions further comprise:
preventing the user of the computer from contributing a comment to the electronic meeting while another participant is contributing a comment to the electronic meeting.

10. The computer-readable media of claim 1, wherein the functions further comprise:
preventing the user of the computer from capturing a display of the computer during the electronic meeting.

11. A method comprising:
joining a user to an electronic meeting;
displaying a list of participants in the electronic meeting;
receiving electronic messages, wherein each electronic message comprises a comment contributed by one of the participants; and
displaying each comment without displaying an identity of the participant who contributed the comment.

12. The method of claim 11, wherein the electronic messages are first electronic messages, and wherein the method further comprises:
responsive to input from the user, sending a second electronic message to a participant who contributed a comment, the second electronic message comprising a request for an identity of the participant who contributed the comment;
receiving a third electronic message, the third electronic message comprising the identity of the participant who contributed the comment; and
responsive to receiving the third electronic message, displaying the identity of the participant who contributed the comment.

13. The method of claim 11, wherein the electronic messages are first electronic messages, and wherein the method further comprises:
responsive to input from the user, sending a second electronic message to a participant who contributed a comment, the second electronic message comprising a request to capture the comment;
receiving a third electronic message, the third electronic message granting the request; and
responsive to the third electronic message, allowing the user to capture the comment within the electronic meeting.

14. The method of claim 11, wherein the electronic messages are first electronic messages, wherein the electronic meeting is a first electronic meeting, and wherein the method further comprises:
responsive to input from the user, sending a second electronic message to a participant who contributed a comment, the second electronic message comprising a request to provide the comment to a second electronic meeting;
receiving a third electronic message, the third electronic message granting the request; and
responsive to the third electronic message, allowing the user to provide the comment to the second electronic meeting.

15. The method of claim 11, wherein:
the second electronic message further comprises a request for an identity of the participant who contributed the comment;
the third electronic message comprises the identity of the participant who contributed the comment; and
the method further comprises displaying the identity of the participant who contributed the comment responsive to the third electronic message.

16. The method of claim 11, wherein:
one of the electronic messages includes an indication of one of a plurality of conviction levels for the respective comment; and
the method further comprises indicating the one of the plurality of conviction levels for the respective comment responsive to receiving the one of the electronic messages.

17. The method of claim 11, wherein:
one of the participants is associated with an avatar that does not indicate an identity of the participant; and
the method further comprises displaying the avatar with comments contributed by the one of the participants.

18. The method of claim 11, further comprising:
displaying each electronic message only for a predetermined interval.

19. The method of claim 11, further comprising:
preventing the user from contributing a comment to the electronic meeting while another participant is contributing a comment to the electronic meeting.

20. The method of claim 11, further comprising:
preventing the user of the computer from capturing a display of the computer during the electronic meeting.
